(19) United States
(12) Patent Application Publication
(10) Pub. No.: US 2007/0265943 A1
(43) Pub. Date: Nov. 15, 2007

(54) Product management system, product management apparatus, and product management method

(75) Inventor: Shigeo Kuwabara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/878,148

(22) Filed: Jul. 20, 2007

Related U.S. Application Data
(63) Continuation of application No. PCT/JP05/00649, filed on Jan. 20, 2005.

(51) Int. Cl. A01K 5/02

(52) U.S. Cl. 705/29

(57) ABSTRACT

Product information stored in an IC tag attached to a product, which has been read by an IC tag reader, is input. Whether the product is a new product is determined on the basis of a product master file. When the product is a new product, the product information is registered in the product master file. When the product is not a new product, corresponding product information regarding the product, which has been registered in the product master file, is updated, and inventory management information including position information regarding the product and the number of items of the product is updated on the basis of position information regarding the IC tag reader. Accordingly, the product master file can be automatically updated, and inventory management including position information regarding each product and the number of items can be implemented.

### BACKGROUND OF THE INVENTION

1. Field of the Invention

The present invention relates to management of articles of trade or commerce (hereinafter referred to as “products”) at stores, and more particularly to the technique of automating registration, updating, and deletion of products in a product master file by monitoring the location of each product on the basis of an integrated circuit (IC) tag attached to the product.

2. Description of the Related Art

In a known product management system at a store, the product code of a product is input to a computing system at the time, for example, the product is ordered. If a product master file does not contain the product code of the product, the product code and product information regarding the product are registered as new information in the product master file. In addition, a bar code attached to the product at the time the product arrived at the store is manually read using a bar-code reader, and the read data is input to the computing system. Accordingly, the product master file is updated. In order to ensure that the product master file is reliably updated, which involves manual steps, at some stores the maintenance of the product master file is done at the end of each business or transaction to keep the product master file in proper condition (for example, see Japanese Unexamined Patent Application Publication No. 5-114082, pp 2-3).

However, a great amount of labor is required to read a bar code attached to each product using a bar-code reader and to input the read data into a computing system. Since this labor involves human factors, the reliability of the labor is difficult to ensure. In particular, a large store handles a great number of products, and these products must be inspected one at a time in order to determine the accurate number of items of each product (hereinafter the term “items” will be used to indicate products of the same type). Even when bar codes are employed, information on each product must be read one at a time, resulting in a huge amount of working time. No matter how many people engage in this labor under the present situation, this will not be sufficient. Thus, in general the number of items of each product is only roughly calculated.

In the case of food products, it is expedient to reduce the number of products in inventory even though it may involve a reduction in the price by 20% or 50% according to the freshness date. However, the use of bar code or two-dimensional bar code does not allow rewriting of the information or addition of a new piece of information at the store, and such a bar code can only contain information including the product code and name. In order to change the price of a product, a seal indicating that the product is on a discount is manually adhered onto the corresponding bar code to prevent a point-of-sale (POS) terminal from reading the bar code, and, in order that a cashier will not forget to reduce the price, the cashier is required to remove the seal, perform an operation to allow the POS terminal to read the bar code, and then give a discount. Alternatively, instead of a seal indicating a discount, a discount bar code is adhered, and the cashier allows the POS terminal to read two bar codes including one indicating the product and the other indicating a discount. As has been described, such a process involves many steps.

In the current product management system, the arrival of a certain product and the purchase of the product by a consumer can be detected in cooperation with a POS system. However, the number of items of this product in a backyard and the number of items arranged on a shelf at the store cannot be detected. To this end, an employee at the store must periodically look around the store. If the number of items arranged on the shelf becomes less, the employee must replenish the shelf with items taken out from the backyard. The employee cannot order the product on time unless the employee checks available space in the backyard.

The area of the product master file is physically limited. The free space for storing product information regarding a new product becomes insufficient unless unnecessary information is deleted from the product master file. In particular, products such as seasonal products are not in demand at all times. Yet, information regarding these products is currently contained in the product master file at all times, occupying a large area of the product master file.

### SUMMARY OF THE INVENTION

The present invention provides a system and a method for automating registration, updating, and deletion of products in a product master file by monitoring the location of each product on the basis of an integrated circuit (IC) tag attached to the product

According to one aspect of the present invention, there is provided a method comprising providing a product master file for storing one or more records of product information regarding products to be handled at the store, the one or more records each representing the same type of products, inputting tagged product information stored in an integrated-circuit tag attached to a tagged product without contacting the integrated-circuit tag, registering the tagged product information as a new record in the product master file in the case of the product master file lacking a record corresponding to the tagged product, and updating a record in the product master file corresponding to the tagged product on the basis of the tagged product information in the case of the product master file having the record corresponding to the tagged product.

According to another aspect of the present invention, there is provided a method further comprising updating inventory management information including position information regarding a product and the number of items of the product, on the basis of position information regarding the integrated-circuit-tag reader through which the tagged product information has been read by the product-information-obtaining part.

According to still another aspect of the present invention, there is provided a method further comprising deleting a record of product information regarding a product from the product master file in the case of the product information satisfying a predetermined condition, on the basis of the product information regarding the product stored in the product master file.

### BRIEF DESCRIPTION OF THE DRAWINGS

FIG. 1 is a diagram of an overall configuration of a a system according to an embodiment of the present invention;

FIG. 2 illustrates an exemplary product master file (on a store basis) according to the present invention;

FIG. 3 illustrates an exemplary history table according to the present invention;

FIG. 4 illustrates an exemplary setting table according to the present invention;

FIG. 5 illustrates an exemplary inventory table according to the present invention;

FIG. 6 illustrates exemplary product information stored in an IC tag according to the present invention;

FIG. 7 is a flowchart of a process of registering/updating information in a product master file according to the present invention;

FIG. 8 is a flowchart of a process of deleting information from the product master file according to the present invention;

FIG. 9 is a flowchart of a process of updating inventory information according to the present invention; and

FIG. 10 is a diagram of an exemplary floor plan of a store to which the present invention is applied.

### DESCRIPTION OF THE PREFERRED EMBODIMENT

A preferred embodiment of the present invention will now herein be described in detail with reference to the drawings.

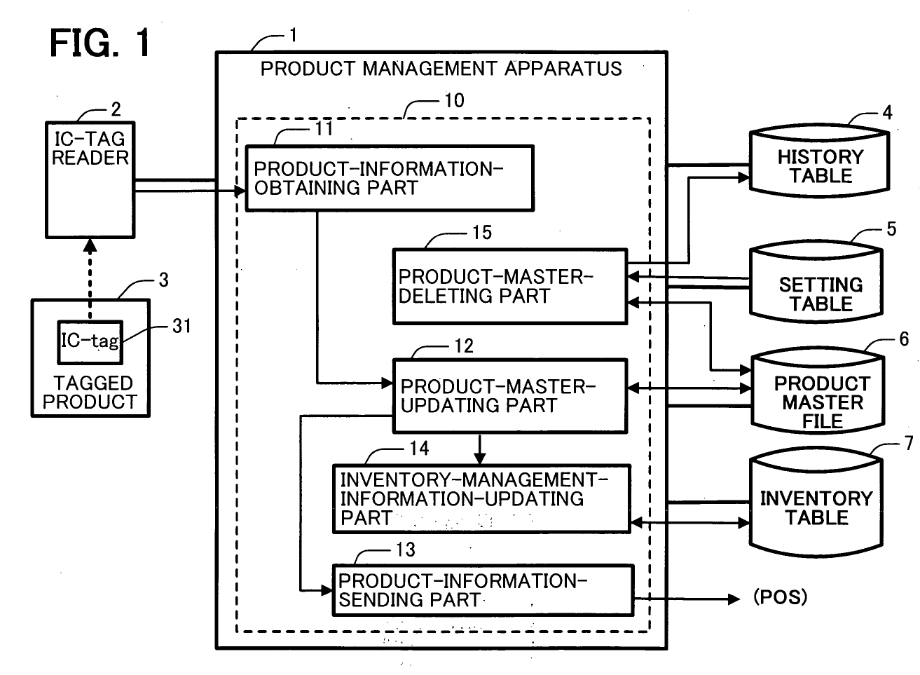

FIG. 1 shows the overall configuration of a system according to an embodiment of the present invention.

An IC-tag reader 2, communicably connected to a product management apparatus 1, reads product information from an IC tag 31 attached to an arbitrary product 3 which exists at a store. Hereinafter, the term “tagged product” will be used to indicate an arbitrary product with an IC-tag 31 attached thereon which exists at the store, and the term “tagged product information” will be used to indicate product information stored in the IC tag 31 attached to the “tagged product”.

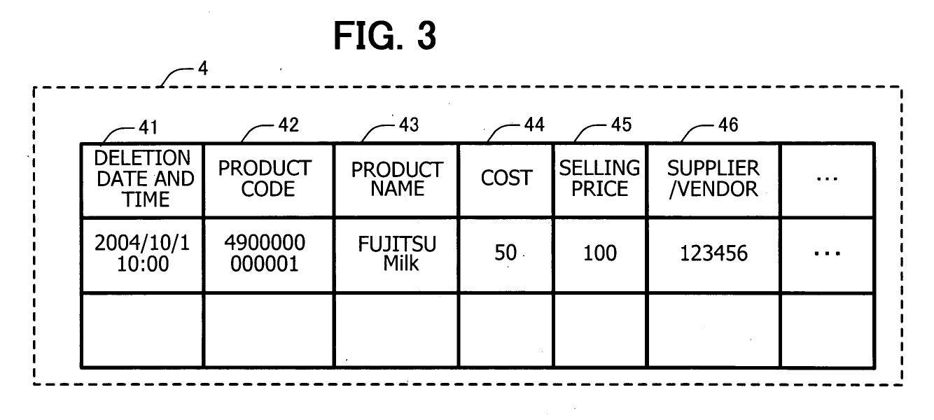

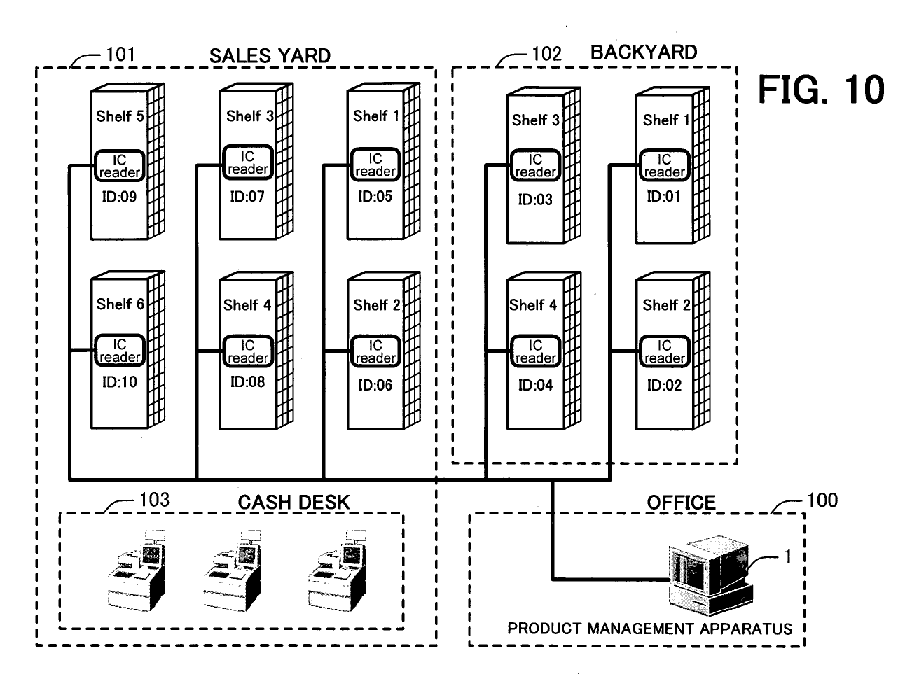

A history table 4 for storing product information deleted from a product master file 6 shown in FIG. 3, a setting table 5 for storing a condition for storing product information in the product master file 6, the product master file 6 for storing product information regarding products to be handled in a store, and an inventory table 7 for storing information regarding products in inventory are connected to the product management apparatus 1. Although only one IC-tag reader 2, which is connected to the product management apparatus 1, is shown in FIG. 1 for convenience, multiple IC-tag readers 2 can be connected to the product management apparatus 1 in order to manage inventory information including position information regarding products, as shown in FIG. 10.

A product management apparatus 1 includes the following: a product-information-obtaining part 11 for inputting the tagged product information stored in the IC tag 31 attached to the tagged product 3, which has been read by the IC-tag reader 2, to the product management apparatus 1; product-master-updating part 12 for determining, on the basis of the product master file 6, whether a tagged product indicated by the tagged product information input by the product-information-obtaining part 11 is a new product and, if the tagged product is a new product, registering the product information in the product master file 6, and, if the product is not a new product, updating corresponding product information regarding the tagged product, which has been registered in the product master file 6; inventory-management-information-updating part 14 for updating inventory management information including position information regarding a product and the number of items of the product, which are contained in the inventory table 7, on the basis of position information (for example, apparatus ID) regarding the IC-tag reader 2 serving as an input source for the product-information-obtaining part 11; and product-master-deleting part 15 for deleting product information regarding a product from the product master file 6 in the case where the product information satisfies a predetermined condition stored in the setting table 5 on the basis of the product information regarding the product, which is stored in the product master file 6.

Product-information-obtaining part 11 reads tagged product information stored in an IC tag 31 attached to an tagged product 3, which is, for example, read at predetermined time intervals by an IC-tag reader 2 connected to a product management apparatus 1, into the product management apparatus 1. Product-master-updating part 12 determines whether the product indicated by the tagged product information is a new product by determining whether the tagged product information is stored in a product master file 6. When the tagged product information is not stored in the product master file 6, the tagged product information is registered in the product master file 6 as new product information. When the tagged product information is stored in the product master file 6, corresponding product information regarding the tagged product, which is registered in the product master file 6, is updated.

A product-information-sending part 13 can be configured to send the product information registered or updated by the product-master-updating part 12 to a POS system.

Accordingly, when a tagged product that has arrived at a store is a new product in the product master file 6 used in the POS system, tagged product information regarding the new product is registered in the product master file 6. When a tagged product that has arrived at a store is not a new product, corresponding product information in the product master file 6 is updated. Therefore, the product master file 6 can be maintained to reflect the latest state upon arrival of a product at the store.

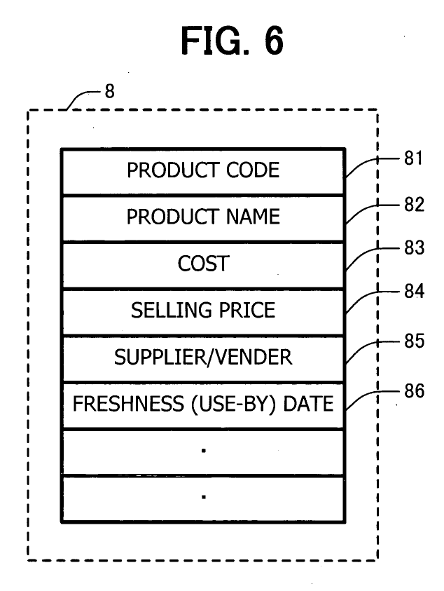

Since the IC tag 31 can store a larger amount of information than a bar code can store, besides a product code and a product name, for example, as shown in FIG. 6, the cost, selling price, freshness date, and the like can be stored in the IC tag 31. Since information stored in the IC tag 31 can be rewritten, the IC-tag reader 2 can determine the freshness date and then rewrite the selling price in the IC tag 31, or the POS system at a cashier can automates predetermined discount processing based on determination of the freshness date stored in the IC tag 31. In the case that a common product master file is used by the product management apparatus 1 and the POS system, the product-information-sending part 13 is unnecessary.

When the product management apparatus 1 includes inventory-management-information-updating part 14 for updating inventory management information (for example, an inventory table 7) including position information regarding a product and the number of items of the product, in cooperation with the product master file updating processing, on the basis of position information regarding the IC-tag reader 2 serving as an input source for the product-information-obtaining part 11 (for example, an IC tag reader whose apparatus identification (ID) is 01 is placed on “shelf 1” in a backyard), the number of items of a certain product arranged on a shelf in the sales yard or the number of items of the certain product stored in the backyard can be detected without checking the sales yard or backyard. Although only one IC tag reader 2 is connected to the product management apparatus 1 in FIG. 1 for convenience, as will be shown in FIG. 10, multiple IC tag readers are generally placed. If management of products in inventory, including position information, is unnecessary, only one IC tag reader may be placed at a product entrance through which tagged products are carried in.

When the product management apparatus 1 includes product-master-deleting part 15 for deleting product information regarding a product from the product master file 6 in the case where the product information satisfies a predetermined condition on the basis of the product information regarding the product, which is stored in the product master file 6, unnecessary product information can be deleted from the product master file 6.

The product management apparatus 1 according to the present invention can be configured to include a product management program 10 including instructions for allowing a computer system to execute each function of the above-mentioned parts (a product-information-obtaining part 11, product-master-updating means 12, the product-information-sending part 13, inventory-management-information-updating part 14, and product-master-deleting part 15).

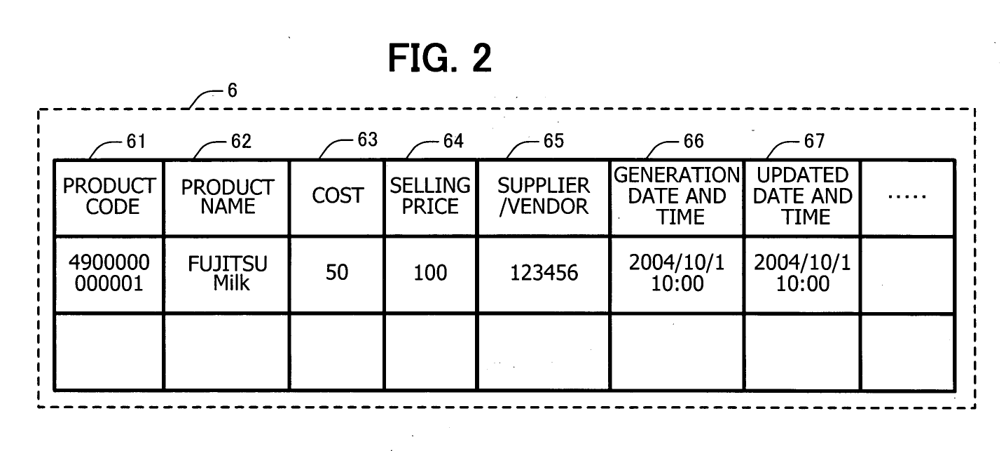

FIG. 2 illustrates an exemplary product master file (on a store basis) according to the present invention.

The product master file 6 (on a store basis) stores product information regarding products to be handled at each store. In this embodiment, for example, the following product information regarding each product is stored in the product master file 6: a product code 61 for identifying the product, a product name 62 indicating the name of the product, a cost 63 indicating the cost of the product, a selling price 64 indicating the selling price of the product, a supplier/vendor 65 of the product, a generation date and time 66 indicating the registration date and time of the product information, and an updated date and time 67 of the product information if the product information has been updated.

FIG. 3 shows an exemplary history table 4. The history table 4 stores product information deleted from the product master file 6. In this embodiment, for example, the following product information regarding each product is stored in the history table 4: a deletion date and time 41, a product code 42, a product name 43, a cost 44, a selling price 45, a supplier/vendor 45, and so on.

For example, in the case where a malfunction occurs in the system and product information is deleted, the deleted product information can be recovered from the history table 4. Further, in the case where information that had been stored before in the product master file 6 becomes necessary, the information can be retrieved from the history table 4.

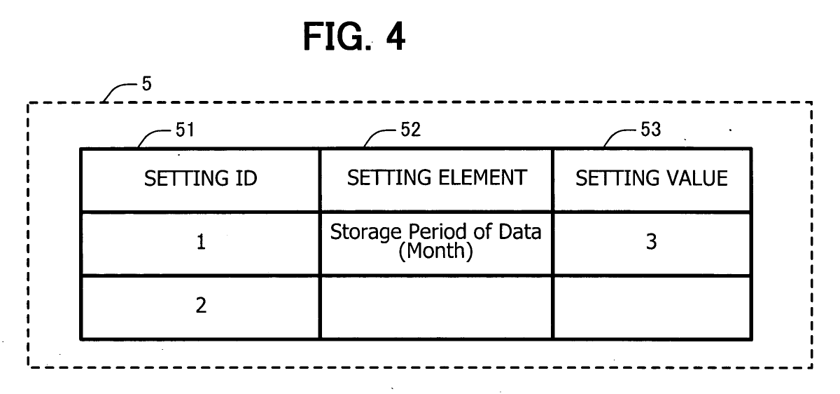

FIG. 4 shows an exemplary setting table 5. The setting table 5 stores a setting ID 51 for identifying a setting, a setting element 52 indicating, for example, a storage period of data (product information) or the like, and a setting value 53 which is dependant on the setting element 52. For example, in the case of the storage period of data, “3” (indicating 3 months) can be stored as a setting value 53.

By registering multiple setting elements according to the setting IDs 51, different setting elements 52 can be selected on a product's attribute basis, such as foods, household articles, and the like.

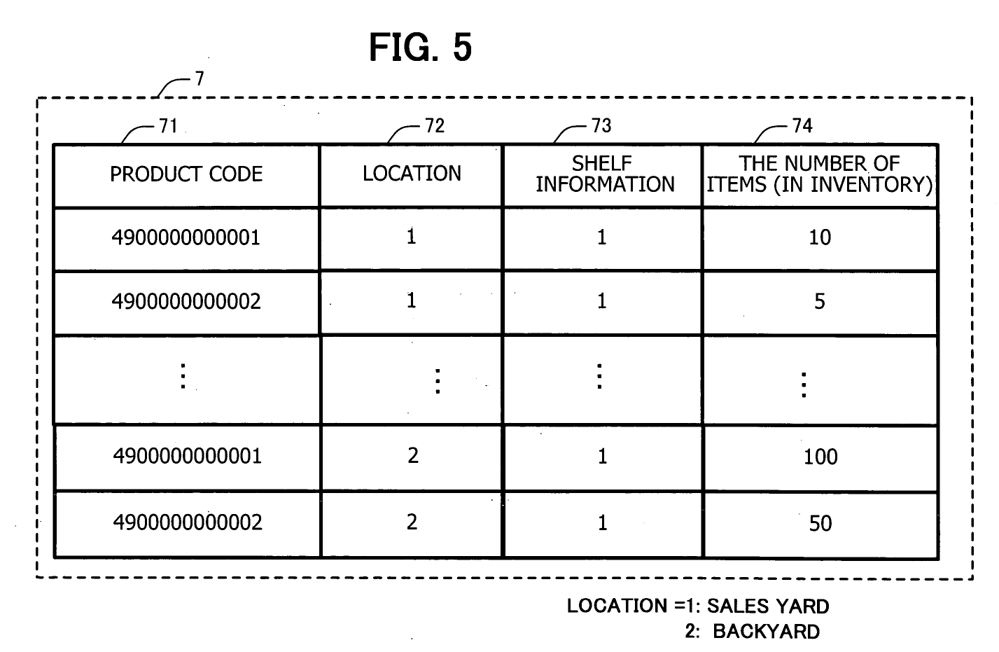

FIG. 5 shows an exemplary inventory table 7 according to the present invention. The inventory table 7 stores a product code 71 for identifying each product, a location 72 of a product (in this embodiment, whether the product is in a sales yard or in a backyard), shelf information 73 indicating a shelf on which the product is placed, and the number of items 74 of the product in inventory.

FIG. 6 shows exemplary tagged product information stored in the IC tag 31 according to the present invention. In contrast to known bar codes or two-dimensional bar codes, the IC tag 31 can store a large amount of information. In this embodiment, the IC tag 31 stores, for example, the following tagged product information 8 regarding an tagged product: product code 81 for identifying the tagged product; a product name 82 indicating the name of the tagged product, a cost 83 indicating the cost of the tagged product, a selling price 84 indicating the selling price of the tagged product, a supplier/vendor 85 of the tagged product, and a freshness (use-by) date 86 indicating a freshness (use-by) date of the tagged product. In general, these pieces of tagged product information are stored in the IC tag 31 at the shipping source of the product. In contrast to bar codes or two-dimensional bar codes, the IC tag 31 can be rewritten. Thus, the selling price may be rewritten on the basis of a comparison between the freshness (use-by) date 86 and the current time by the IC-tag reader 2.

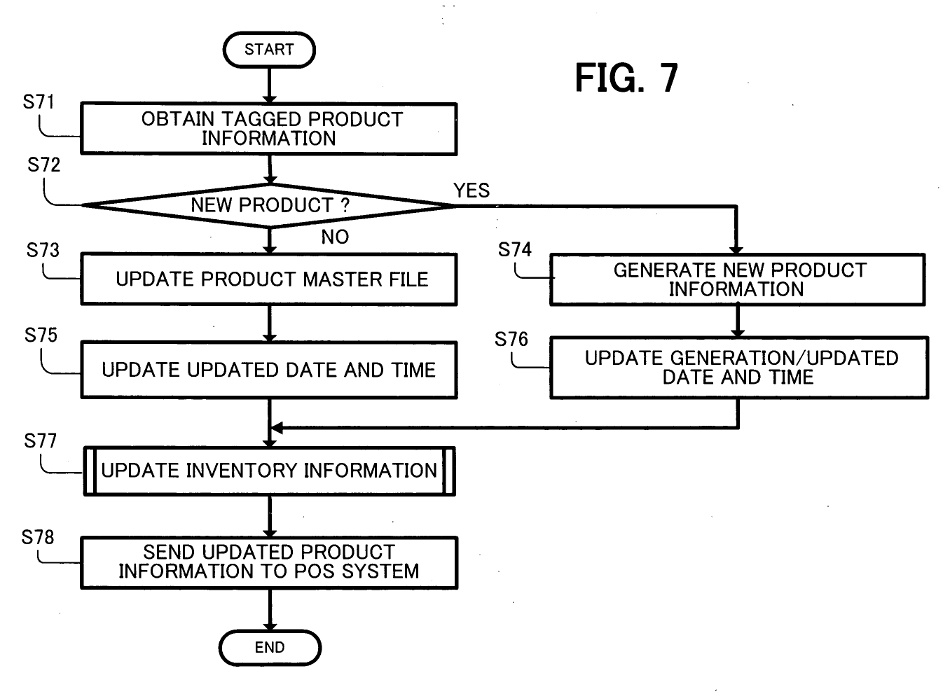

FIG. 7 is a flowchart of a process of registering/updating information in the product master file 6 according to the present invention. When the product management system to which the present invention is applied starts running, for example, the product management program 10 is activated and continues to be resident until the product management system stops running. In response to activation of the product management program 10, tagged product information stored in the IC tag 31 attached to a tagged product is read from the IC-tag reader 2 (S71).

Although the flowchart concerns the flow of processing of tagged product information read by the IC-tag reader 2 from the IC tag 31 attached to one tagged product 3, the IC-tag reader 2 is configured to read tagged product information stored in IC tags attached to all tagged products existing in an area.covered by the IC-tag reader 2. Thus, this process is repeated for all the tagged products read by the IC-tag reader 2. Further, since multiple IC-tag readers 2 are placed in a store, the product management program 10 is executed to perform the above-described process for all the IC-tag readers 2. Since the repeated processes are not an essential feature of the present invention, detailed descriptions thereof are omitted.

Next, the process retrieves, on the basis of a product code 81 stored in the tagged product information 8 read from the read IC tag 31, a corresponding product code 61 in product information stored in the product master file 6. If the corresponding product code 61 already exists in the product master file 6, that is, the tagged product is not a new product (NO), the process proceeds to step S73 to update the product master file 6. If the corresponding product code 61 does not exist in the product master file 6, that is, the tagged product is a new product (YES), the process proceeds to step S74 to register the tagged product information in the product master file 6 (S72).

The updating of the product master file 6 involves updating product information of a product, which is stored in the product master file 6 and includes matching product code, on the basis of the product information 81 stored in the tagged product information 8 read from the read IC tag 31, which includes the cost 83, selling price 84, supplier/vender 85, and the like (S73), and storing the current date and time as the updated date and time 67(S75), and then the process proceeds to step S77 to update the inventory information.

In contrast, the registration of information in the product master file 6 involves registering the tagged product information stored in the read IC tag 31, which includes the product code 81, product name 82, cost 83, selling price 84, supplier/vender 85, and the like, as new product information in the product master file 6 (S74) and storing the current date and time as the generation date and time 66 and the updated date and time 67(S76), and the process proceeds to step S77 to update the inventory information.

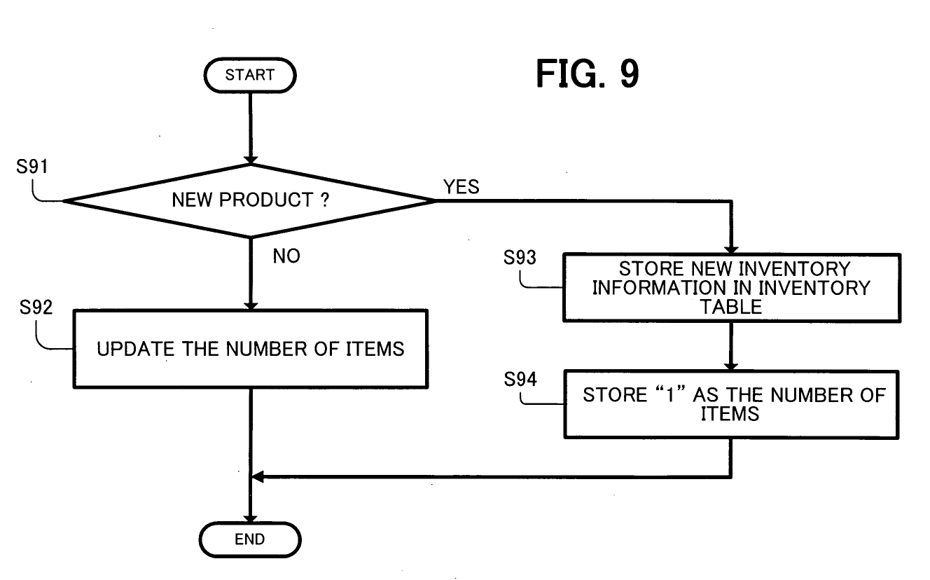

See FIG. 9 for the details of the updating of the inventory information in step S77. Thereafter, in order to reflect the latest state in the product master file 6 used by a POS system, the updated product information or newly registered product information in the product master file 6 is sent to the POS system (S78). It is noted that the processing in step S78 is unnecessary in the case where the product master file 6 is shared by the product management system and the POS system.

After the above-described process has been performed for all the IC-tag readers 2, the product management program 10 enters a wait state. The product management program 10 is reactivated in synchronization with the IC-tag reader 2 reading the IC tag 31 attached to the next tagged product.

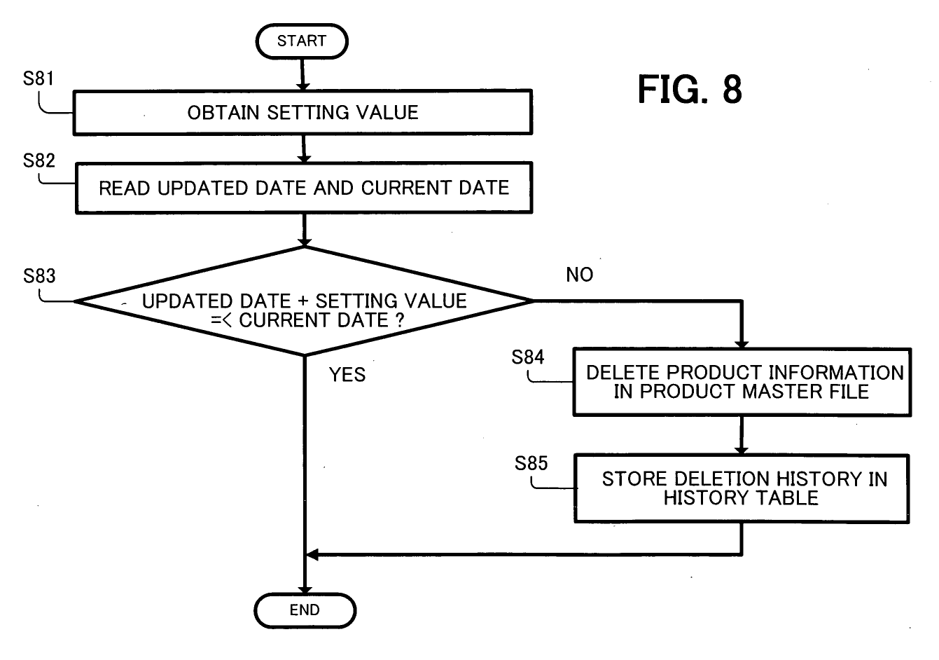

FIG. 8 is a flowchart of a process of deleting information from the product master file 6 according to the present invention. This process is executed independent of the process of registering/updating information in the product master file 6, which is executed by the product management program 10 shown in FIG. 7. The process of deleting information from the product master file 6 can be scheduled to be executed as batch processing when the load of the main process is low, such as when the store is closed. Although the flowchart shown in FIG. 8 concerns the flow of processing of product information regarding one product registered in the product master file 6, this process is repeated for product information regarding all products registered in the product master file 6. Since the repeated processes are not an essential feature of the present invention, detailed descriptions thereof are omitted.

Upon activation of the process, a setting element 52 and a setting value 53 are read from the setting table 5, which have been set in advance prior to start-up of the product management system (S81). In this case, it is regarded that the data storage condition (storage period of data) requires that data be stored for three months as shown in FIG. 4. This means that, when data is not updated in the three months since the previous updated date, this data should be deleted. Next, a date portion (updated date) of the updated date and time stored in the product master file 6 is obtained, and a data portion of a timer value, which indicates a current date and time, is read (S82). The current date is compared with the sum of the updated date and the storage period (for example, three months). If the sum of the updated date and the storage period (three months) is equal to or less than the current date (YES), it is regarded that the storage period has not expired, and the process ends. Otherwise (NO), it is regarded that the storage period has expired, and the process proceeds to step S84 to delete the product information (S83). The deletion of the product information involves deleting the product information in the product master file 6 (S84) and storing, as a deletion history, the deletion date and time and the deleted product information in the history table 4 (S85).

FIG. 9 is a flowchart of a process of updating the inventory information according to the present invention. The process determines whether the currently-being-processed tagged product is a new product (the determination method is the same as that in S72 of FIG. 7) (S91). If the tagged product is a new product, the process stores the product code 71, a location 72, and shelf information 73 in the inventory table 7 (S93) and stores “1” as the number of items in inventory 74 (S94). If the tagged product is not a new product, the process adds “1” to the number of items (in inventory) 74, which is included in inventory information including the matching location 72 and shelf information 73, among pieces of inventory information of the product including the matching product code 71 in the inventory table 7, to update the inventory information (S92). If there is no inventory information including the matching location 72 and shelf information 73, the process generates new inventory information and stores the product code 71, location 72, shelf information 73, and the number-of items (in inventory) 74 of “1”. The location 72 (a sales yard or a backyard) and shelf information 73, serving as position information regarding the product, can be obtained on the basis of the apparatus ID of the IC-tag reader 2 from which the tagged product information has been read. For example, as shown in FIG. 10, in the case where tagged product information has been read from an IC-tag reader whose apparatus ID is “05”, the location is “a sales yard”, and the shelf is “Shelf 1”.

FIG. 10 is a diagram of an exemplary floor plan of a store to which the present invention is applied. In this case, the floor of the store is build up with a sales yard 101 including a cash desk 103, a backyard 102, and an office 100 including a product management apparatus 1. In order to manage inventory information including position information regarding a tagged product, for example, in the case where such information is managed according to shelves, one IC-tag reader (indicated as an “IC reader” in FIG. 10) is placed on each of the shelves. The intensity of radio waves is adjusted and the type of IC tag to use is selected so that the area covered by each IC-tag reader 2 does not interfere with the areas covered by the other IC-tag readers 2. Each of the IC-tag readers 2 is connected to the product management apparatus 1 (computer). The product management apparatus 1 can determine at which position (shelf) each IC-tag reader is placed on the basis of the apparatus ID (indicated as an “ID:xx” in FIG. 10 where “xx” is ID value) thereof.

According to an aspect of the embodiments, the embodiments are implemented in computing hardware and/or software. The many features and advantages of the embodiments are apparent from the detailed specification and, thus it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A product management system for managing products at a store, comprising:
an integrated-circuit-tag reader for reading tagged product information stored in an integrated-circuit tag attached to a tagged product without contacting the integrated-circuit tag; and
a product management apparatus communicably connected to one or more integrated-circuit-tag readers, the product management apparatus comprising:
a product master file for storing one or more records of product information regarding products to be handled at the store, the one or more records each representing the same type of products;
a product-information-obtaining part for inputting the tagged product information read by the integrated-circuit-tag reader to the product management apparatus; and
a product-master-updating part for updating the product master file, the product-master-updating part registering the tagged product information as a new record in the product master file in the case of the product master file lacking a record corresponding to the tagged product, the product-master-updating part updating a record in the product master file corresponding to the tagged product on the basis of the tagged product information in the case of the product master file having the record corresponding to the tagged product.

2. The product management system of claim 1, wherein the product management apparatus further comprises an inventory-management-information-updating part for updating inventory management information including position information regarding a product and the number of items of the product, on the basis of position information regarding the integrated-circuit-tag reader through which the tagged product information has been read by the product-information-obtaining part.

3. The product management system of claim 1, wherein the product management apparatus further comprises a product-information-deleting part for deleting a record of product information regarding a product from the product master file in the case of the product information satisfying a predetermined condition, on the basis of the product information regarding the product stored in the product master file.

4. A product management apparatus for managing products in a store, the product management apparatus communicably connected to one or more integrated-circuit-tag for reading tagged product information stored in an integrated-circuit tag attached to a tagged product without contacting the integrated-circuit tag, the product management apparatus comprising:
a product master file for storing one or more records of product information regarding products to be handled at the store, the one or more records each representing the same type of products;
a product-information-obtaining part for inputting the tagged product information read by the integrated-circuit-tag reader to the product management apparatus; and
a product-master-updating part for updating the product master file, the product-master-updating part registering the tagged product information as a new record in the product master file in the case of the product master file lacking a record corresponding to the tagged product, the product-master-updating part updating a record in the product master file corresponding to the tagged product on the basis of the tagged product information in the case of the product master file having the record corresponding to the tagged product.

5. The product management apparatus of claim 4, further comprising an inventory-management-information-updating part for updating inventory management information including position information regarding a product and the number of items of the product, on the basis of position information regarding the integrated-circuit-tag reader through which the tagged product information has been read by the product-information-obtaining part.

6. The product management apparatus of claim 4, further comprising a product-information-deleting part for deleting a record of product information regarding a product from the product master file in the case of the product information satisfying a predetermined condition, on the basis of the product information regarding the product stored in the product master file.

7. A product management method for managing products at a store, comprising:
providing a product master file for storing one or more records of product information regarding products to be handled at the store, the one or more records each representing the same type of products;
inputting tagged product information stored in an integrated-circuit tag attached to a tagged product without contacting the integrated-circuit tag;
registering the tagged product information as a new record in the product master file in the case of the product master file lacking a record corresponding to the tagged product; and
updating a record in the product master file corresponding to the tagged product on the basis of the tagged product information in the case of the product master file having the record corresponding to the tagged product.

8. The product management method of claim 7, further comprising updating inventory management information including position information regarding a product and the number of items of the product, on the basis of position information regarding the integrated-circuit-tag reader through which the tagged product information has been read by the product-information-obtaining part.

9. The product management method of claim 7, further comprising deleting a record of product information regarding a product from the product master file in the case of the product information satisfying a predetermined condition, on the basis of the product information regarding the product stored in the product master file.
